(19) United States
(12) Patent Application Publication
(10) Pub. No.: US 2018/0097664 A1
(43) Pub. Date: Apr. 5, 2018

(54) Method And Apparatus For Handling Aperiodic Reference Signal In Mobile Communications

(71) Applicant: MediaTek Inc., Hsinchu City (TW)

(72) Inventor: Kuhn-Chang Lin, Chiayi City (TW)

(21) Appl. No.: 15/711,185

(22) Filed: Sep. 21, 2017

Related U.S. Application Data
(60) Provisional application No. 62/401,990, filed on Sep. 30, 2016.

(51) Int. Cl. H04L 25/02; H04W 24/10; H04L 1/16; H04L 5/00

(52) U.S. Cl. CPC H04L 25/0228; H04W 24/10; H04W 72/1278; H04L 5/0057; H04L 1/1607

(57) ABSTRACT

Various solutions for handling aperiodic reference signal (RS) with respect to user equipment (UE) in mobile communications are described. A UE may receive aperiodic RS information from a network apparatus. The UE may determine whether aperiodic RS is presented. If the aperiodic RS is not presented, the UE may perform first data decoding procedure. If the aperiodic RS is presented, the UE may perform second data decoding procedure according to the aperiodic RS information. The UE may further determine whether a trigger command for triggering channel state information (CSI) reporting is presented. The UE may perform CSI measurement according to the aperiodic RS information if the trigger command is presented and transmit a CSI report to the network apparatus.

### CROSS REFERENCE TO RELATED PATENT APPLICATION

The present disclosure claims the priority benefit of U.S. Provisional Patent Application No. 62/401,990, filed on 30 Sep. 2016, the content of which is incorporated by reference in its entirety.

### TECHNICAL FIELD

The present disclosure is generally related to mobile communications and, more particularly, to aperiodic reference signal handling in mobile communications.

### BACKGROUND

Unless otherwise indicated herein, approaches described in this section are not prior art to the claims listed below and are not admitted as prior art by inclusion in this section.

There are various well-developed and well-defined cellular communications technologies in telecommunications that enable wireless communications using mobile terminals, or user equipment (UE). For example, the Global System for Mobile communications (GSM) is a well-defined and commonly used communications system, which uses time division multiple access (TDMA) technology, which is a multiplex access scheme for digital radio, to send voice, video, data, and signaling information (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Long-Term Evolution (LTE), as well as its derivatives such as LTE-Advanced and LTE-Advanced Pro, is a standard for high-speed wireless communication for mobile phones and data terminals.

In the LTE communication system, reference signals are transmitted from base stations to user equipment (UE). The reference signals may be used by the UE for performing time-frequency synchronization or signal strength measurement. One of the reference signals is called channel state information-reference signal (CSI-RS) which is used by the UE to estimate channel condition and report channel quality information (CQI) to the base stations. In LTE, the CSI-RS is transmitted periodically. The base stations are configured to broadcast the CSI-RS periodically and the UE is configured to monitor and receive the periodic CSI-RS. Since the CSI-RS is scheduled periodically, it may occupy a certain number of radio resources and produce significant signaling overhead. Therefore, aperiodic CSI-RS is developed for reducing signaling overhead between the base stations and the UE.

However, since the aperiodic CSI-RS is transmitted dynamically, there is possibility that the aperiodic CSI-RS is overlapped with other downlink data and may cause interference on the UE. That is, a UE may receive downlink data from a base station and receive aperiodic CSI-RS from another base station at the same time. If the UE is not aware of the aperiodic CSI-RS, the UE may deem the aperiodic CSI-RS as interference signals. Downlink data decoding and downlink signal measurement of the UE may be interfered by the aperiodic CSI-RS.

Accordingly, it is important to avoid the possible interference and conflict caused by the aperiodic CSI-RS. Therefore, in developing future communication system, it is needed to provide protection mechanisms for the UE and the base stations to properly handle the aperiodic CSI-RS transmission.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues with respect to aperiodic reference signal handling for a communication apparatus. In implementations in accordance with the present disclosure, the communication apparatus may receive aperiodic CSI-RS information from the network apparatus. With the aperiodic CSI-RS information, the communication apparatus is able to perform some protection schemes to prevent or to compensate the interference caused by the aperiodic CSI-RS.

In one aspect, a method may involve an apparatus receiving aperiodic RS information from a network apparatus. The method may also involve the apparatus determining whether aperiodic RS is presented. The method may further involve the apparatus performing first data decoding procedure if the aperiodic RS is not presented or performing second data decoding procedure according to the aperiodic RS information if the aperiodic RS is presented.

In another aspect, a method may involve an apparatus receiving aperiodic RS information from a network apparatus. The method may also involve the apparatus determining whether a trigger command for triggering channel state information (CSI) reporting is presented. The method may further involve the apparatus performing CSI measurement according to the aperiodic RS information if the trigger command is presented and transmitting a CSI report to the network apparatus.

In yet another aspect, a method may involve an apparatus receiving neighboring aperiodic RS information from a neighbor cell. The method may also involve the apparatus transmitting at least one of the neighboring aperiodic RS information and serving aperiodic RS information to a user equipment (UE). The method may further involve the apparatus transmitting a downlink control channel indication to the UE.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a block diagram of an example communication apparatus and an example network apparatus in accordance with an implementation of the present disclosure.

FIG. 3 is a flowchart of an example process in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to aperiodic reference signal handling in mobile communications. According to the present disclosure, a number of possible solutions may be implemented separately or jointly. That is, although these possible solutions may be described below separately, two or more of these possible solutions may be implemented in one combination or another.

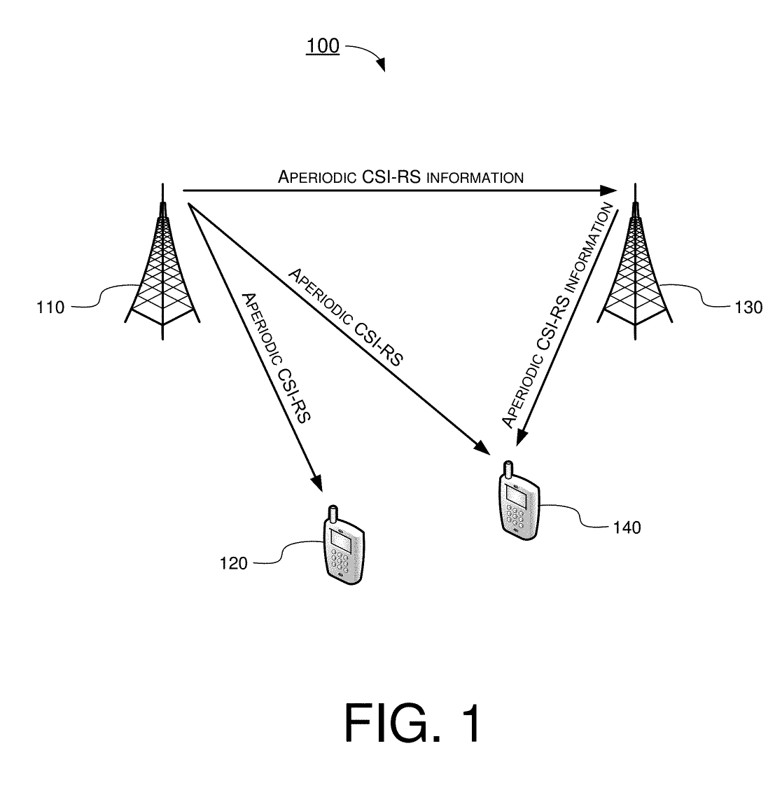

FIG. 1 illustrates an example scenario 100 under schemes in accordance with implementations of the present disclosure. Scenario 100 involves user equipment (UE) 120, UE 140, evolved node B (eNB) 110 and eNB 130. ENB 110 and eNB 130 are network apparatus (e.g., base stations), which may be part of a wireless network (e.g., a LTE network, a LTE-Advanced network, a LTE-Advanced Pro network, a 5^{th} Generation (5G) network, a New Radio (NR) network or an Internet of Things (loT) network). The network apparatus (e.g., eNB 110 and eNB 130) is able to transmit reference signals (e.g., channel state information-reference signal (CSI-RS)) to the UE (e.g., UE 120 and UE 140). The CSI-RS may be used by the UE to estimate channel condition and report channel quality information (CQI) to the network apparatus. In the present disclosure, the CSI-RS is an aperiodic CSI-RS which is dynamically transmitted by the network apparatus. If the UE is not aware of the aperiodic CSI-RS transmitted from a neighbor cell or a serving cell, the UE may deem the aperiodic CSI-RS as interference signals. Downlink data decoding and downlink signal measurement of the UE may be interfered by the aperiodic CSI-RS. Accordingly, a protection scheme is needed between the UE and the network apparatus for preventing the interference caused by the aperiodic CSI-RS.

Referring to FIG. 1, UE 120 is wirelessly connected to eNB 110 and UE 140 is wirelessly connected to eNB 130 respectively. ENB 110 is the serving cell of UE 120 and is the neighbor cell of UE 140. ENB 130 is the serving cell of UE 140 and is the neighbor cell of UE 120. When eNB 110 is configured to transmit aperiodic CSI-RS in a broadcast channel, the aperiodic CSI-RS may be received by both UE 120 and UE 140. For UE 140, the aperiodic CSI-RS received from eNB 110 is interference signal and may interfere the downlink signal from eNB 130. Accordingly, in order to prevent the interference caused by neighboring aperiodic CSI-RS received from eNB 110, a protection scheme is needed between eNB 130 to UE 140.

Specifically, eNB 130 may be configured to receive neighboring aperiodic CSI-RS information from a neighbor cell (e.g., eNB 110) via an eNB-to-eNB interface (e.g., X2 interface). Before transmitting aperiodic CSI-RS to the UE, eNB 110 may be configured to transmit its aperiodic CSI-RS information to inform eNB 130 in advance. After receiving aperiodic CSI-RS information from eNB 110, eNB 130 is aware of the presence of the neighboring aperiodic CSI-RS information. ENB 130 is able to perform some protection schemes for UE 140 to avoid the interference caused by the neighboring aperiodic CSI-RS. For example, eNB 130 may be configured not to schedule downlink data or downlink resources to UE 140 when the neighboring aperiodic CSI-RS is presented to prevent the interference from the neighboring aperiodic CSI-RS. In another example, eNB 130 may be configured not to schedule downlink data at the time-frequency regions with the presence of the neighboring aperiodic CSI-RS to avoid conflict or overlap of the downlink data and the neighboring aperiodic CSI-RS. These schemes may be used for those UEs which are not capable of dealing with the interference of the aperiodic CSI-RS from neighbor cells.

In another aspect, eNB 130 may be configured to transmit at least one of the neighboring aperiodic CSI-RS information of eNB 110 and the serving aperiodic RS information of eNB 130 to UE 140. After receiving the neighboring aperiodic CSI-RS and/or the serving aperiodic RS information from eNB 130, UE 140 is aware of the presence of the neighboring aperiodic CSI-RS information and/or the serving aperiodic CSI-RS information and may be able to perform some protection schemes at UE side to avoid the interference caused by the neighboring aperiodic CSI-RS information and/or the serving aperiodic CSI-RS information. For reducing signaling overhead between the eNB and the UE, the eNB may be configured to broadcast a plurality of possible configurations of the aperiodic CSI-RS information in advance. The eNB may be configured to further transmit a downlink control channel indication with fewer data bits to inform the UE. The downlink control channel indication is used to indicate that the neighboring aperiodic CSI-RS information and/or the serving aperiodic CSI-RS information is presented or to indicate a trigger command for triggering CSI measurement and reporting.

Specifically, the neighboring aperiodic CSI-RS information and/or the serving aperiodic CSI-RS information may comprise at least one aperiodic RS identity (ID). Each of the aperiodic RS ID may further corresponds to the aperiodic RS information comprising at least one of time-frequency information of the aperiodic RS, resource element (RE) map of the aperiodic RS, zero power RS, antenna port information of the aperiodic RS, scrambling information of the aperiodic RS and coding information of the aperiodic RS. The neighboring aperiodic CSI-RS information and/or the serving aperiodic CSI-RS information may be transmitted to the UE in a broadcast channel or in an eNB-to-UE interface such as, for example and without limitation, a system information block (SIB) message, a master information block (MIB) message or a radio resource control (RRC) message. The neighboring aperiodic CSI-RS information may also be transmitted between eNBs in an eNB-to-eNB interface such as, for example and without limitation, an X2 interface. The downlink control channel indication may be carried in, for example and without limitation, common search space of a downlink control channel (e.g., physical downlink control channel (PDCCH)), a dedicated channel or an existing channel.

In some implementations, the aperiodic CSI-RS information transmitted from the eNB to the UE may comprise explicit information such as, for example and without limitation, aperiodic CSI-RS information, aperiodic RS IDs, cell IDs, interference information, interference sources or interference causes. In some implementations, the aperiodic CSI-RS information transmitted from the eNB to the UE may only comprise implicit information such as, for example and without limitation, RE maps covered by interference RS, zero power RS or other pre-defined RS. For efficiency, the aperiodic CSI-RS information transmitted from the eNB to the UE may directly indicate a time-frequency zone comprising interfering aperiodic CSI-RS for the UE to perform protection schemes.

At UE side, UE 140 may be configured to receive aperiodic CSI-RS information from eNB 130. The received aperiodic CSI-RS information may comprise a plurality of configurations of the neighboring aperiodic CSI-RS information of eNB 110 and/or a plurality of configurations of the serving aperiodic CSI-RS information of eNB 130. Each configuration of the aperiodic CSI-RS information may comprise at least one of time-frequency information of the aperiodic RS, RE maps of the aperiodic RS, zero power RS, antenna port information of the aperiodic RS, scrambling information of the aperiodic RS and coding information of the aperiodic RS. The aperiodic CSI-RS information is used to inform UE 140 the possible configurations of the aperiodic CSI-RS of eNB 110 and/or eNB 130, and is received before the transmission of the aperiodic CSI-RS from eNB 110 and/or eNB 130. UE 140 may receive the aperiodic CSI-RS information via a broadcast channel of eNB 130.

UE 140 may be configured to receive a downlink control channel indication from eNB 130. The downlink control channel indication may be transmitted in a downlink control channel (e.g., PDCCH), a dedicated channel or an existing channel. UE 140 may be further configured to determine whether the aperiodic CSI-RS is presented according to the downlink control channel indication. If the aperiodic CSI-RS is not presented, UE 140 may be configured to perform a first data decoding procedure. In the first data decoding procedure, since there is no aperiodic CSI-RS, UE 140 may perform a normal de-rate matching procedure. If the aperiodic CSI-RS is presented, it means that the aperiodic CSI-RS is activated and will be transmitted by eNB 110 and/or eNB 130. The downlink control channel indication may further indicate the activated aperiodic CSI-RS ID. The aperiodic CSI-RS ID may correspond to one of the plurality of configurations of the aperiodic CSI-RS information received before. In view of the aperiodic CSI-RS ID, UE 140 may be configured to perform a second data decoding procedure according to the corresponding aperiodic CSI-RS information. In the second data decoding procedure, UE 140 may perform a de-rate matching procedure by excluding data bits of the aperiodic CSI-RS to avoid the interference caused by the aperiodic CSI-RS. For example, UE 140 may perform the de-rate matching procedure without using the data bits of the aperiodic CSI-RS or by punching the data bits of the aperiodic CSI-RS.

In some implementations, UE 140 may perform the de-rate matching procedure with interference cancellation according to the aperiodic CSI-RS information. Since UE 140 already has the property information of the aperiodic CSI-RS, UE 140 may be able to perform interference cancellation to compensate or cancel the interference caused by the aperiodic CSI-RS. For example, UE 140 may perform the de-rate matching procedure by de-weighting or zeroing the log likelihood ratio (LLR) of the REs occupied by the aperiodic CSI-RS. UE 140 may also perform the de-rate matching procedure by lowering the reliability or the weighting of the REs occupied by the aperiodic CSI-RS. UE 140 may be further configured to consider antenna port information/configuration (e.g., Multi-input Multi-output (MIMO), Single-input Multi-output (MIMO) or Single-input Single-output (SISO)) when performing the data decoding procedure and the interference cancellation procedure.

In some implementations, the downlink control channel indication may be used to indicate a trigger command for triggering CSI measurement and reporting. The trigger command may be carried in a downlink control indicator (DCI) for downlink scheduling or in a specific DCI for transmitting the trigger command. UE 140 may be configured to receive the downlink control channel indication and determine whether the trigger command is presented according to the downlink control channel indication. If the trigger command is not presented, UE 140 does not need to perform CSI measurement and reporting. If the trigger command is presented, it means that CSI reporting is activated and UE 140 needs to perform CSI measurement and reporting according to the received neighboring aperiodic CSI-RS information and/or serving aperiodic CSI-RS information. The downlink control channel indication may further indicate the activated aperiodic CSI-RS ID. The aperiodic CSI-RS ID may correspond to one of the plurality of configurations of the aperiodic CSI-RS information received before. In view of the aperiodic CSI-RS ID, UE 140 may be configured to perform CSI measurement according to the corresponding aperiodic CSI-RS information. In the CSI measurement, UE 140 may perform channel quality measurement by excluding data bits of the aperiodic CSI-RS to avoid the interference caused by the aperiodic CSI-RS. For example, UE 140 may perform channel quality measurement and CSI calculation without considering the data bits of the aperiodic CSI-RS or by punching the data bits of the aperiodic CSI-RS. Alternatively, UE 140 may be configured not to measure the time-frequency regions or REs of the aperiodic CSI-RS.

In some implementations, UE 140 may perform the CSI measurement with interference cancellation according to the aperiodic CSI-RS information. Since UE 140 already has the property information of the aperiodic CSI-RS, UE 140 may be able to perform interference cancellation to compensate or cancel the interference caused by the aperiodic CSI-RS. After performing the CSI measurement, UE 140 may be configured to transmit a CSI report to eNB 130. The CSI report may comprise the channel quality information without including the interference caused by the aperiodic CSI-RS. The CSI report may also comprise the information of the interference caused by the aperiodic CSI-RS. For example, UE 140 may estimate and extract the interference parts caused by the aperiodic CSI-RS and indicate the interference parts in the CSI report.

### Illustrative Implementations

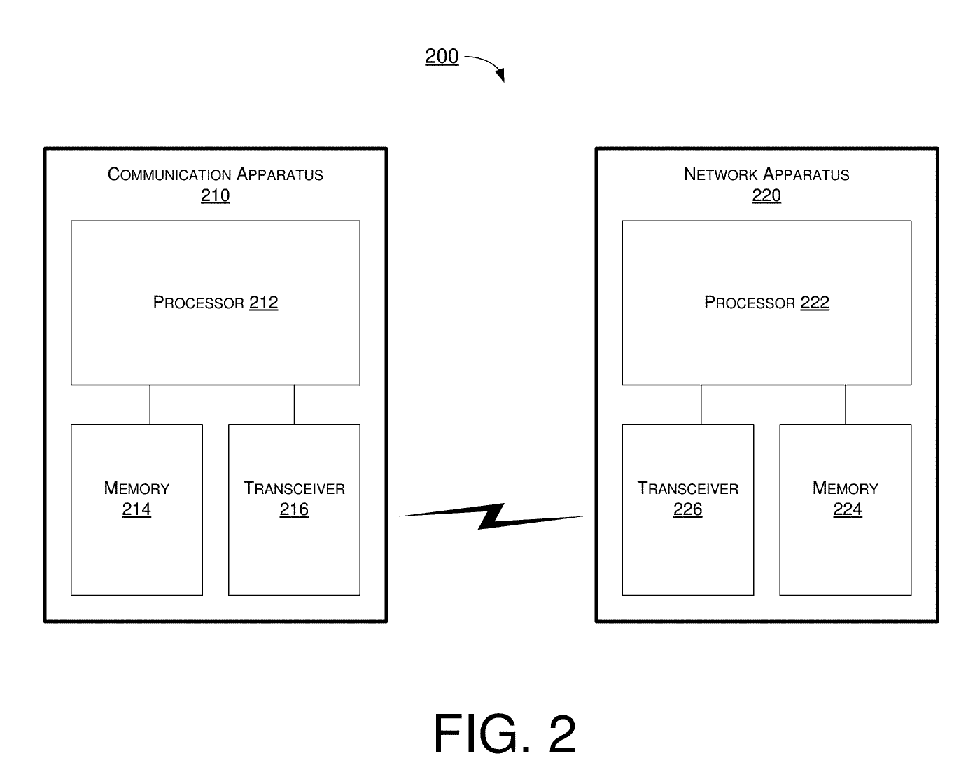

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to power consumption reduction with respect to user equipment in wireless communications, including scenario 100 described above as well as processes 300, 400 and 500 described below.

Communication apparatus 210 may be a part of an electronic apparatus, which may be a user equipment (UE) such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an loT apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, or one or more complex-instruction-set-computing (CISC) processors. Communication apparatus 210 may include at least some of those components shown in FIG. 2 such as a processor 212, for example. communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus, which may be a network node such as a base station, a small cell, a router or a gateway. For instance, network apparatus 220 may be implemented in an eNodeB in a LTE, LTE-Advanced or LTE-Advanced Pro network or in a gNB in a 5G, NR or loT network. Alternatively, network apparatus 220 may be implemented in the form of one or more IC chips such as, for example and without limitation, one or more single-core processors, one or more multi-core processors, or one or more CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE and network apparatus 220 is implemented in or as a network node of a communication network.

The following description pertains to the operations, functionalities and capabilities of network apparatus 220.

In some implementations, processor 222 may be configured to transmit, via transceiver 226, reference signals (e.g., channel state information-reference signal (CSI-RS)) to the UE. The CSI-RS may be used by the UE to estimate channel condition and report channel quality information (CQI) to network apparatus 220. In the present disclosure, processor 222 may be configured to transmit, via transceiver 226, an aperiodic CSI-RS in a dynamic way. Processor 222 may be configured to transmit, via transceiver 226, the aperiodic CSI-RS in a broadcast channel.

In some implementations, processor 222 may be configured to receive neighboring aperiodic CSI-RS information from a neighbor cell via an eNB-to-eNB interface (e.g., X2 interface). After receiving aperiodic CSI-RS information from the neighbor cell, processor 222 is aware of the presence of the neighboring aperiodic CSI-RS information. Network apparatus 220 is able to perform some protection schemes for the UE to avoid the interference caused by the neighboring aperiodic CSI-RS. For example, processor 222 may be configured not to schedule downlink data or downlink resources to the UE when the neighboring aperiodic CSI-RS is presented to prevent the interference from the neighboring aperiodic CSI-RS. In another example, processor 222 may be configured not to schedule downlink data at the time-frequency regions with the presence of the neighboring aperiodic CSI-RS to avoid conflict or overlap of the downlink data and the neighboring aperiodic CSI-RS. These schemes may be used for those UEs which are not capable of dealing with the interference of the aperiodic CSI-RS from neighbor cells.

In some implementations, processor 222 may be configured to transmit at least one of the neighboring aperiodic CSI-RS information of the neighbor cell and the serving aperiodic RS information of network apparatus 220 to the UE. For reducing signaling overhead between network apparatus 220 and the UE, processor 222 may be configured to broadcast a plurality of possible configurations of the aperiodic CSI-RS information in advance. Each configuration may comprise at least one of time-frequency information of the aperiodic RS, resource element (RE) map of the aperiodic RS, zero power RS, antenna port information of the aperiodic RS, scrambling information of the aperiodic RS and coding information of the aperiodic RS. Processor 222 may be configured to further transmit a downlink control channel indication with fewer data bits to inform the UE. The downlink control channel indication is used to indicate that the neighboring aperiodic CSI-RS information and/or the serving aperiodic CSI-RS information is presented or to indicate a trigger command for triggering CSI measurement and reporting.

In some implementations, processor 222 may be configured to include at least one aperiodic RS identity (ID) in the neighboring aperiodic CSI-RS information and/or the serving aperiodic CSI-RS information transmitted to the UE. Each of the aperiodic RS ID may further corresponds to the aperiodic RS information comprising at least one of time-frequency information of the aperiodic RS, resource element (RE) map of the aperiodic RS, zero power RS, antenna port information of the aperiodic RS, scrambling information of the aperiodic RS and coding information of the aperiodic RS. Processor 222 may transmit the neighboring aperiodic CSI-RS information and/or the serving aperiodic CSI-RS information to the UE in a broadcast channel or in an eNB-to-UE interface such as, for example and without limitation, a system information block (SIB) message, a master information block (MIB) message or a radio resource control (RRC) message. Processor 222 may transmit the downlink control channel indication in, for example and without limitation, common search space of a downlink control channel (e.g., physical downlink control channel (PDCCH)), a dedicated channel or an existing channel.

In some implementations, processor 222 may transmit the aperiodic CSI-RS information with explicit information such as, for example and without limitation, aperiodic CSI-RS information, aperiodic RS IDs, cell IDs, interference information, interference sources or interference causes. In some implementations, processor 222 may transmit the aperiodic CSI-RS information with only implicit information such as, for example and without limitation, RE maps covered by interference RS, zero power RS or other pre-defined RS. For efficiency, processor 222 may directly indicate a time-frequency zone comprising interfering aperiodic CSI-RS for the UE to perform protection schemes.

The following description pertains to the operations, functionalities and capabilities of communication apparatus 210.

In some implementations, processor 212 may be configured to receive, via transceiver 216, reference signals (e.g., channel state information-reference signal (CSI-RS)) from the network apparatus. In the present disclosure, the CSI-RS is an aperiodic CSI-RS which is dynamically transmitted by the network apparatus. If communication apparatus 210 is not aware of the aperiodic CSI-RS transmitted from a neighbor cell or a serving cell, communication apparatus 210 may deem the aperiodic CSI-RS as interference signals. Downlink data decoding and downlink signal measurement of communication apparatus 210 may be interfered by the aperiodic CSI-RS. Accordingly, a protection scheme is needed between communication apparatus 210 and the network apparatus for preventing the interference caused by the aperiodic CSI-RS.

In some implementations, processor 212 may be configured to receive, via transceiver 216, at least one of the neighboring aperiodic CSI-RS information of neighbor cell and the serving aperiodic RS information of serving cell from the network apparatus. After receiving the neighboring aperiodic CSI-RS and/or the serving aperiodic RS information from eNB 130, processor 212 is aware of the presence of the neighboring aperiodic CSI-RS information and/or the serving aperiodic CSI-RS information and may be able to perform some protection schemes to avoid the interference caused by the neighboring aperiodic CSI-RS information and/or the serving aperiodic CSI-RS information.

In some implementations, the received aperiodic CSI-RS information may comprise a plurality of configurations of the neighboring aperiodic CSI-RS information of neighbor cell and/or a plurality of configurations of the serving aperiodic CSI-RS information of serving cell. Each configuration of the aperiodic CSI-RS information may comprise at least one of time-frequency information of the aperiodic RS, RE maps of the aperiodic RS, zero power RS, antenna port information of the aperiodic RS, scrambling information of the aperiodic RS and coding information of the aperiodic RS. The aperiodic CSI-RS information is used to inform communication apparatus 210 the possible configurations of the aperiodic CSI-RS of neighbor cell and/or serving cell, and is received before the transmission of the aperiodic CSI-RS from neighbor cell and/or serving cell. Communication apparatus 210 may receive the aperiodic CSI-RS information via a broadcast channel of the network apparatus.

In some implementations, processor 212 may be configured to receive a downlink control channel indication from the network apparatus. The downlink control channel indication may be transmitted in a downlink control channel (e.g., PDCCH), a dedicated channel or an existing channel. Processor 212 may be further configured to determine whether the aperiodic CSI-RS is presented according to the downlink control channel indication. If the aperiodic CSI-RS is not presented, processor 212 may be configured to perform a first data decoding procedure. In the first data decoding procedure, since there is no aperiodic CSI-RS, processor 212 may perform a normal de-rate matching procedure. If the aperiodic CSI-RS is presented, it means that the aperiodic CSI-RS is activated and will be transmitted by the neighbor cell and/or the serving cell. The downlink control channel indication may further indicate the activated aperiodic CSI-RS ID. The aperiodic CSI-RS ID may correspond to one of the plurality of configurations of the aperiodic CSI-RS information received before. In view of the aperiodic CSI-RS ID, processor 212 may be configured to perform a second data decoding procedure according to the corresponding aperiodic CSI-RS information. In the second data decoding procedure, processor 212 may perform a de-rate matching procedure by excluding data bits of the aperiodic CSI-RS to avoid the interference caused by the aperiodic CSI-RS. For example, processor 212 may perform the de-rate matching procedure without using the data bits of the aperiodic CSI-RS or by punching the data bits of the aperiodic CSI-RS.

In some implementations, processor 212 may perform the de-rate matching procedure with interference cancellation according to the aperiodic CSI-RS information. Since processor 212 already has the property information of the aperiodic CSI-RS, processor 212 may be able to perform interference cancellation to compensate or cancel the interference caused by the aperiodic CSI-RS. For example, processor 212 may perform the de-rate matching procedure by de-weighting or zeroing the log likelihood ratio (LLR) of the REs occupied by the aperiodic CSI-RS. Processor 212 may also perform the de-rate matching procedure by lowering the reliability or the weighting of the REs occupied by the aperiodic CSI-RS. Processor 212 may be further configured to consider antenna port information/configuration (e.g., Multi-input Multi-output (MIMO), Single-input Multi-output (MIMO) or Single-input Single-output (SISO)) when performing the data decoding procedure and the interference cancellation procedure.

In some implementations, the downlink control channel indication may be used to indicate a trigger command for triggering CSI measurement and reporting. The trigger command may be carried in a downlink control indicator (DCI) for downlink scheduling or in a specific DCI for transmitting the trigger command. Processor 212 may be configured to receive the downlink control channel indication and determine whether the trigger command is presented according to the downlink control channel indication. If the trigger command is not presented, processor 212 does not need to perform CSI measurement and reporting. If the trigger command is presented, it means that CSI reporting is activated and processor 212 needs to perform CSI measurement and reporting according to the received neighboring aperiodic CSI-RS information and/or serving aperiodic CSI-RS information. The downlink control channel indication may further indicate the activated aperiodic CSI-RS ID. The aperiodic CSI-RS ID may correspond to one of the plurality of configurations of the aperiodic CSI-RS information received before. In view of the aperiodic CSI-RS ID, processor 212 may be configured to perform CSI measurement according to the corresponding aperiodic CSI-RS information. In the CSI measurement, processor 212 may perform channel quality measurement by excluding data bits of the aperiodic CSI-RS to avoid the interference caused by the aperiodic CSI-RS. For example, processor 212 may perform channel quality measurement and CSI calculation without considering the data bits of the aperiodic CSI-RS or by punching the data bits of the aperiodic CSI-RS. Alternatively, processor 212 may be configured not to measure the time-frequency regions or REs of the aperiodic CSI-RS.

In some implementations, processor 212 may perform the CSI measurement with interference cancellation according to the aperiodic CSI-RS information. Since processor 212 already has the property information of the aperiodic CSI-RS, processor 212 may be able to perform interference cancellation to compensate or cancel the interference caused by the aperiodic CSI-RS. After performing the CSI measurement, processor 212 may be configured to transmit a CSI report to the network apparatus. The CSI report may comprise the channel quality information without including the interference caused by the aperiodic CSI-RS. The CSI report may also comprise the information of the interference caused by the aperiodic CSI-RS. For example, processor 212 may estimate and extract the interference parts caused by the aperiodic CSI-RS and indicate the interference parts in the CSI report.

### Illustrative Processes

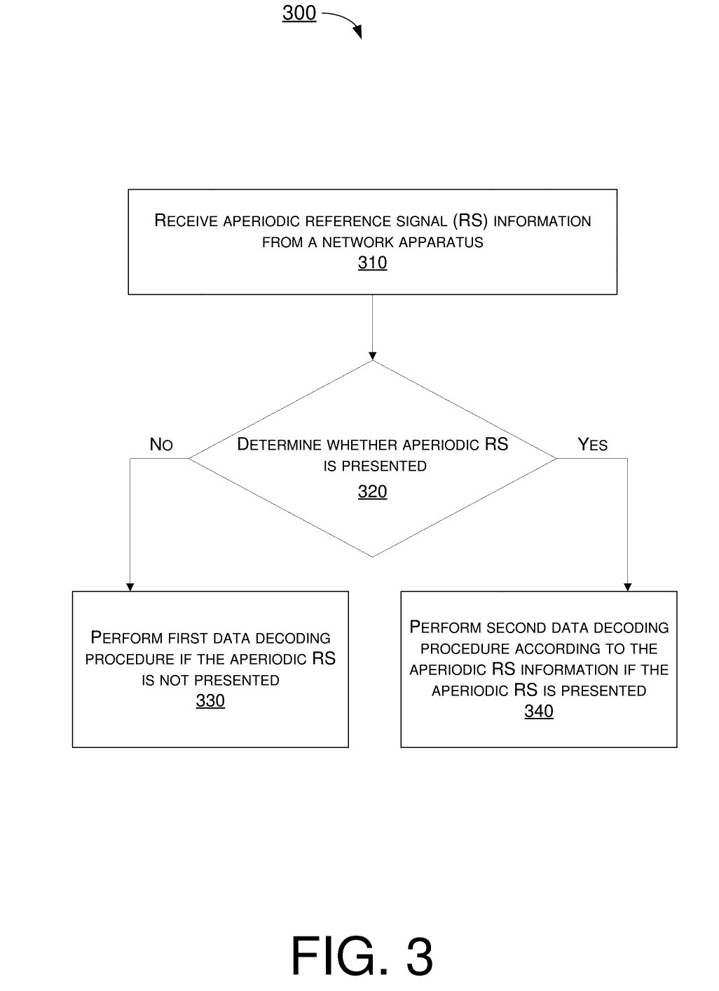

FIG. 3 illustrates an example process 300 in accordance with an implementation of the present disclosure. Process 300 may be an example implementation of scenario 100, whether partially or completely, with respect to aperiodic reference signal handling in accordance with the present disclosure. Process 300 may represent an aspect of implementation of features of communication apparatus 210. Process 300 may include one or more operations, actions, or functions as illustrated by one or more of blocks 310, 320, 330 and 340. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210. Process 300 may begin at block 310.

At 310, process 300 may involve communication apparatus 210 receiving aperiodic reference signal (RS) information from a network apparatus. Process 300 may proceed from 310 to 320.

At 320, process 300 may involve communication apparatus 210 determining whether aperiodic RS is presented. If yes, process 300 may proceed from 320 to 330. If no, process 300 may proceed from 320 to 340.

At 330, process 300 may involve communication apparatus 210 performing first data decoding procedure if the aperiodic RS is not presented.

At 340, process 300 may involve communication apparatus 210 performing second data decoding procedure according to the aperiodic RS information if the aperiodic RS is presented.

In some implementations, in the step of performing the second data decoding procedure, process 300 may involve communication apparatus 210 performing de-rate matching by excluding data bits of the aperiodic RS.

In some implementations, in the step of performing the second data decoding procedure, process 300 may involve communication apparatus 210 performing de-rate matching with interference cancellation according to the aperiodic RS information.

In some implementations, in the step of determining whether aperiodic RS is presented, process 300 may involve communication apparatus 210 determining whether aperiodic RS is presented according to a downlink control channel indication received from the network apparatus.

In some implementations, the aperiodic RS information is received from a broadcast channel. The aperiodic RS information may comprise a plurality of aperiodic RS configurations. The aperiodic RS information may further comprise at least one of time-frequency information of the aperiodic RS, resource element (RE) map of the aperiodic RS, zero power RS, antenna port information of the aperiodic RS, scrambling information of the aperiodic RS and coding information of the aperiodic RS.

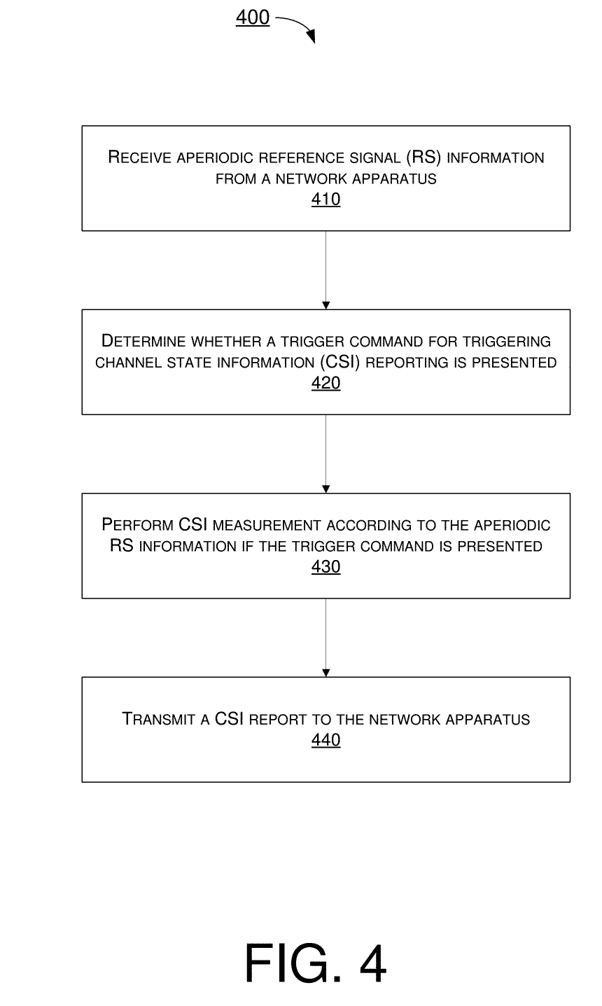

FIG. 4 illustrates an example process 400 in accordance with an implementation of the present disclosure. Process 400 may be an example implementation of scenario 100, whether partially or completely, with respect to aperiodic reference signal handling in accordance with the present disclosure. Process 400 may represent an aspect of implementation of features of communication apparatus 210. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 210 or any suitable UE or machine type devices. Solely for illustrative purposes and without limitation, process 400 is described below in the context of communication apparatus 210. Process 400 may begin at block 410.

At 410, process 400 may involve communication apparatus 210 receiving aperiodic reference signal (RS) information from a network apparatus. Process 400 may proceed from 410 to 420.

At 420, process 400 may involve communication apparatus 210 determining whether a trigger command for triggering channel state information (CSI) reporting is presented. Process 400 may proceed from 420 to 430.

At 430, process 400 may involve communication apparatus 210 performing CSI measurement according to the aperiodic RS information if the trigger command is presented. Process 400 may proceed from 430 to 440.

At 440, process 400 may involve communication apparatus 210 transmitting a CSI report to the network apparatus.

In some implementations, in the step of performing the CSI measurement, process 400 may involve communication apparatus 210 performing the CSI measurement by excluding data bits of the aperiodic RS.

In some implementations, in the step of performing the CSI measurement, process 400 may involve communication apparatus 210 performing the CSI measurement with interference cancellation according to the aperiodic RS information.

In some implementations, in the step of determining whether the trigger command is presented, process 400 may involve communication apparatus 210 determining whether the trigger command is presented according to a downlink control channel indication received from the network apparatus.

In some implementations, the aperiodic RS information is received from a broadcast channel. The aperiodic RS information may comprise a plurality of aperiodic RS configurations. The aperiodic RS information may further comprise at least one of time-frequency information of the aperiodic RS, resource element (RE) map of the aperiodic RS, zero power RS, antenna port information of the aperiodic RS, scrambling information of the aperiodic RS and coding information of the aperiodic RS. The CSI report may indicate interference caused by aperiodic RS.

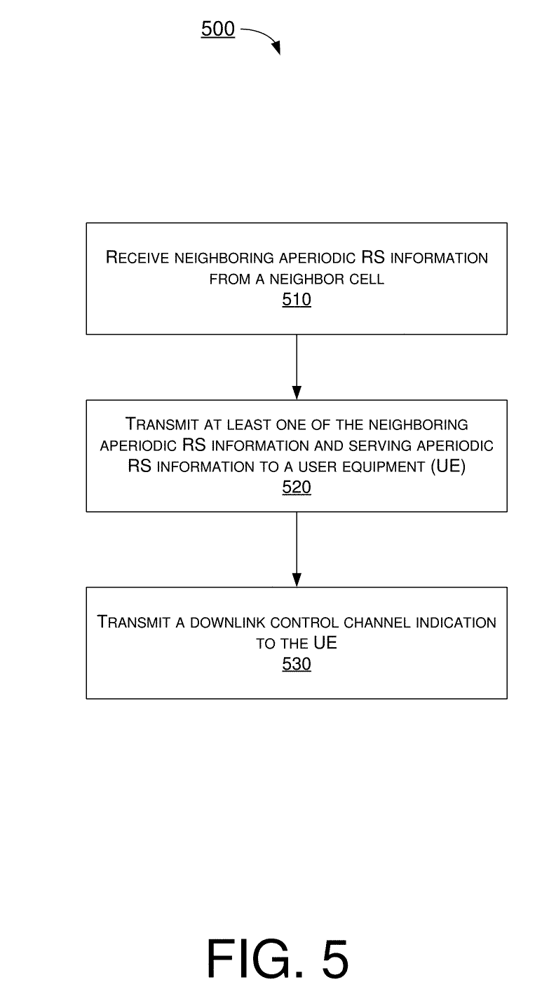

FIG. 5 illustrates an example process 500 in accordance with an implementation of the present disclosure. Process 500 may be an example implementation of scenario 100, whether partially or completely, with respect to aperiodic reference signal handling in accordance with the present disclosure. Process 500 may represent an aspect of implementation of features of network apparatus 220. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by network apparatus 220 or any suitable network node. Solely for illustrative purposes and without limitation, process 500 is described below in the context of network apparatus 220. Process 500 may begin at block 510.

At 510, process 500 may involve network apparatus 220 receiving neighboring aperiodic RS information from a neighbor cell. Process 500 may proceed from 510 to 520.

At 520, process 500 may involve network apparatus 220 transmitting at least one of the neighboring aperiodic RS information and serving aperiodic RS information to a user equipment (UE). Process 500 may proceed from 520 to 530.

At 520, process 500 may involve network apparatus 220 transmitting a downlink control channel indication to the UE.

In some implementations, at least one of the neighboring aperiodic RS information and the serving aperiodic RS information is transmitted in a broadcast channel. The downlink control channel indication may be used to indicate that at least one of the neighboring aperiodic RS information and the serving aperiodic RS information is presented. The downlink control channel indication may further be used to indicate a trigger command for triggering CSI reporting. The neighboring aperiodic RS information comprises at least one of time-frequency information of the aperiodic RS, resource element (RE) map of the aperiodic RS, zero power RS, antenna port information of the aperiodic RS, scrambling information of the aperiodic RS and coding information of the aperiodic RS of the neighbor cell.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, aperiodic reference signal (RS) information from a network apparatus;
determining, by the processor of the apparatus, whether aperiodic RS is presented;
performing, by the processor of the apparatus, first data decoding procedure if the aperiodic RS is not presented; and
performing, by the processor of the apparatus, second data decoding procedure according to the aperiodic RS information if the aperiodic RS is presented.

2. The method of claim 1, wherein performing the second data decoding procedure further comprises:
performing, by the processor of the apparatus, de-rate matching by excluding data bits of the aperiodic RS.

3. The method of claim 1, wherein performing the second data decoding procedure further comprises:
performing, by the processor of the apparatus, de-rate matching with interference cancellation according to the aperiodic RS information.

4. The method of claim 1, wherein determining whether aperiodic RS is presented further comprises:
determining, by the processor of the apparatus, whether aperiodic RS is presented according to a downlink control channel indication received from the network apparatus.

5. The method of claim 1, wherein the aperiodic RS information is received from a broadcast channel.

6. The method of claim 1, wherein the aperiodic RS information comprises a plurality of aperiodic RS configurations.

7. The method of claim 1, wherein the aperiodic RS information comprises at least one of time-frequency information of the aperiodic RS, resource element (RE) map of the aperiodic RS, zero power RS, antenna port information of the aperiodic RS, scrambling information of the aperiodic RS and coding information of the aperiodic RS.

8. A method, comprising:
receiving, by a processor of an apparatus, aperiodic RS information from a network apparatus;
determining, by the processor of the apparatus, whether a trigger command for triggering channel state information (CSI) reporting is presented;
performing, by the processor of the apparatus, CSI measurement according to the aperiodic RS information if the trigger command is presented; and
transmitting, by the processor of the apparatus, a CSI report to the network apparatus.

9. The method of claim 8, wherein performing the CSI measurement further comprises:
performing, by the processor of the apparatus, the CSI measurement by excluding data bits of the aperiodic RS.

10. The method of claim 8, wherein performing the CSI measurement further comprises:
performing, by the processor of the apparatus, the CSI measurement with interference cancellation according to the aperiodic RS information.

11. The method of claim 8, wherein determining whether the trigger command is presented further comprises:
determining, by the processor of the apparatus, whether the trigger command is presented according to a downlink control channel indication received from the network apparatus.

12. The method of claim 8, wherein the aperiodic RS information is received from a broadcast channel.

13. The method of claim 8, wherein the aperiodic RS information comprises a plurality of aperiodic RS configurations.

14. The method of claim 8, wherein the aperiodic RS information comprises at least one of time-frequency information of the aperiodic RS, resource element (RE) map of the aperiodic RS, zero power RS, antenna port information of the aperiodic RS, scrambling information of the aperiodic RS and coding information of the aperiodic RS.

15. The method of claim 8, wherein the CSI report indicates interference caused by aperiodic RS.

16. A method, comprising:
receiving, by a processor of an apparatus, neighboring aperiodic RS information from a neighbor cell;
transmitting, by the processor of the apparatus, at least one of the neighboring aperiodic RS information and serving aperiodic RS information to a user equipment (UE); and
transmitting, by the processor of the apparatus, a downlink control channel indication to the UE.

17. The method of claim 16, wherein at least one of the neighboring aperiodic RS information and the serving aperiodic RS information is transmitted in a broadcast channel.

18. The method of claim 16, wherein the downlink control channel indication is used to indicate that at least one of the neighboring aperiodic RS information and the serving aperiodic RS information is presented.

19. The method of claim 16, wherein the downlink control channel indication is used to indicate a trigger command for triggering CSI reporting.

20. The method of claim 16, wherein the neighboring aperiodic RS information comprises at least one of time-frequency information of the aperiodic RS, resource element (RE) map of the aperiodic RS, zero power RS, antenna port information of the aperiodic RS, scrambling information of the aperiodic RS and coding information of the aperiodic RS of the neighbor cell.
